(19) United States
(12) Patent Application Publication
(10) Pub. No.: US 2017/0051533 A1
(43) Pub. Date: Feb. 23, 2017

(54) MOTORIZED CYLINDRICAL LOCK

(71) Applicant: STANLEY SECURITY SOLUTIONS, INC., Indianapolis, IN (US)

(72) Inventors: Steve A. Kester, Indianapolis, IN (US); John McIntire, Anderson, IN (US); Brendon Allen, Indianapolis, IN (US)

(21) Appl. No.: 15/239,049

(22) Filed: Aug. 17, 2016

Related U.S. Application Data
(60) Provisional application No. 62/207,024, filed on Aug. 19, 2015.

(51) Int. Cl. E05B 47/00; E05B 33/00; G07C 9/00; E05B 51/00

(52) U.S. Cl. CPC E05B 47/0012; E05B 51/00; E05B 33/00; G07C 9/00309; E05B 2047/0084; E05B 2047/0088; E05B 2047/0072; G07C 2009/00769

(57) ABSTRACT

The security system comprises a plurality of cylindrical locks that includes a motorized lock configured for local actuation by a mechanical key and/or for remote actuation by an electric signal. The cylindrical lock can operate in a variety of lock functions including classroom security and storeroom operations.

This patent application claims priority to of U.S. Provisional Patent Application No. 62/207,024, filed Aug. 19, 2016, which is hereby incorporated by reference in its entirety.

### I. FIELD OF THE INVENTION

This invention relates generally to cylindrical locks and more specifically cylindrical locks using motorized lockdown capability.

### II. BACKGROUND OF THE INVENTION

Electrically operated door locks are known in the door lock industry. A cylindrical lock includes inside and outside operating actuators, such as levers or knobs, coupled to a latch bolt such that rotation of either lever will retract the latch bolt to allow the door to open. Depending on chassis configuration, cylindrical locks can perform different functions, such a classroom function and storeroom function.

Classroom function locks and storeroom function locks are known in the art. A classroom function lock is always unlocked from the inside of the classroom and can be locked or unlocked from the outside by a key. A storeroom function lock is also always unlocked from the inside. However, a storeroom function typically includes a fixed outside actuator and is normally locked from the outside. Typically, the latch bolt can only be retracted from the outside by a key. When the key is withdrawn, the storeroom function lock is automatically in the locked condition and there is no way, or need, to lock the storeroom function with the key. Because the storeroom function lock cannot be both locked and unlocked from the outside, it is unsuitable for use in a classroom environment.

A motorized lock exists for the storeroom function. The electrification allows for the outside actuator to operate the latch bolt when the motor is in the unlocked position. In the motorized lock, the key can only retract the latch bolt for entry. It cannot lock the storeroom function if the motor is unlocked.

A motorized lock that permits locking and unlocking a cylindrical lock from the outside is needed. It would be a further benefit to allow a classroom function lock to be locked and unlocked wirelessly, as from a centralized security monitoring station or from a portable device such as a remote key fob or cell phone. Yet another benefit would be to make such a motorized lock operate under battery power in a form factor that would allow the lock to be retrofit into existing doors without requiring an external power source.

Notwithstanding the usefulness of the above-described apparatuses, a need still exists for a electromechanical

### III. SUMMARY OF THE INVENTION

This invention provides enhance materials characterization and interferometers to measure the refractive power distribution of contact lens, measure the index of refraction of contact lens material, and characterize the surface profile of both sides of contact lens.

In one embodiment the present invention is a motorized lock assembly, comprising an inside hub and locking pin assembly having an interior opening; a sleeve and driver assembly operately coupled into the inside hub and locking pin assembly; a motor assembly having a motor actuating mechanism; a spindle operately connectedly affixed to the motor assembly; a threaded plunger adapted to receive force from the spindle and configured to activate one or more lock assembly operations; a coupling mechanism drivably coupled to the outer spindle; a plurality of lever spring returns configured to return one or more levers to zero position after an operation; a plurality of thrust plates configured to hold a plurality of sleeves are in position; a chassis frame and retractor assembly having a bolt actuator mechanism configured to retract a latch bolt; a key release for cam assembly configured to a keyed sleeve assembly and configured to rotate, and wherein the keyed sleeve assembly is operate connected to an outside lever and configured to allow lever rotation; a spring plate for a keyed sleeve configured to translate bias force from the lever spring return to ensure one or more levers is returned to zero position after an operation; and an outside hub assembly operately connected to an outside sleeve for threading onto a rose liner, wherein the rose liner can prevent chassis rotation.

In another embodiment, the present invention is a key unit comprising an antenna and a transmitter configured to transmit a radio frequency (RF) signal over the antenna; and a plurality of lock units configured to accept one or more commands, each lock unit comprising: a lock assembly having a motor assembly, a key release assembly, and a chassis assembly, the lock assembly configured to operate a latch bolt in a plurality of positions; an antenna for receiving the RF signal from the key unit; and a reader coupled to the antenna for receiving the RF signal from the key unit, authenticating whether the key unit is authorized, and if the key unit is authenticated, granting access to a secured resource; a circuit board configured to transmit the RF signal to one or more assemblies in the lock assembly; and wherein at least one of the lock units is configured to respond to RF signals and operate a latch bolt in an one of an unlocked or locked position.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “connected” or “attached” includes physical, whether direct or indirect, affixed or adjustably mounted, as for example, the spindle is operately connected to the motor assembly and configured to be operately coupled to the threaded plunger. Thus, unless specified, “connected” or “attached” is intended to embrace any operationally functional connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to accompanying drawings which are provided for illustration purposes as representative of specific exemplary embodiments in which the invention may be practiced. Given the following description of the specification and drawings, the apparatus and methods should become evident to a person of ordinary skill in the art. Further areas of applicability of the present teachings will become apparent from the description provided herein. It is to be understood that other embodiments can be utilized and that structural changes based on presently known structural and/or functional equivalents can be made without departing from the scope of the invention.

### IV. BRIEF DESCRIPTION OF THE DRAWINGS

FIG. 1 illustrates an exploded, perspective view of the motorized cylindrical lock according to the present invention.

FIG. 2A illustrates a partial exploded view of the motor assembly shown in FIG. 1.

FIG. 2B illustrates a front view of FIG. 2A.

FIG. 2C illustrates a cross-sectional view of FIG. 2A.

FIG. 2D illustrates an alternate embodiment of the threaded plunger shown in FIG. 2A.

FIG. 3A illustrates a partial exploded view of the key release cam assembly shown in FIG. 1.

FIG. 3B illustrates a front view of FIG. 3A.

FIG. 3C illustrates a cross-sectional view of FIG. 3A.

FIG. 4A illustrates a constructed, perspective view of the motorized cylindrical lock shown in FIG. 1.

FIG. 4B illustrates a top view of FIG. 4A.

FIG. 4C illustrates a left side view of FIG. 4A.

FIG. 4D illustrates a right side view of FIG. 4A.

FIG. 4E illustrates a front view of FIG. 4A.

FIG. 4F illustrates a back view of FIG. 4A.

FIG. 5A illustrates a cross-sectional view of the constructed motorized cylindrical lock in an unlocked position.

FIG. 5B illustrates a cross-sectional view of the constructed motorized cylindrical lock in a locked position.

Similar reference characters denote corresponding features consistently throughout the attached drawings.

### V. DETAILED DESCRIPTION OF THE DRAWINGS

This description is illustrative of the embodiments of the present invention only and not intended to be limiting. For example, in one embodiment, a device is described which includes a radio frequency (RF) signal transmitter for transmitting a RF carrier signal. The present invention is not limited, however, by the form of wireless signal transmission or any particular communication protocol. To simplify discussion and to allow comparison between figures, like elements are assigned like reference numerals.

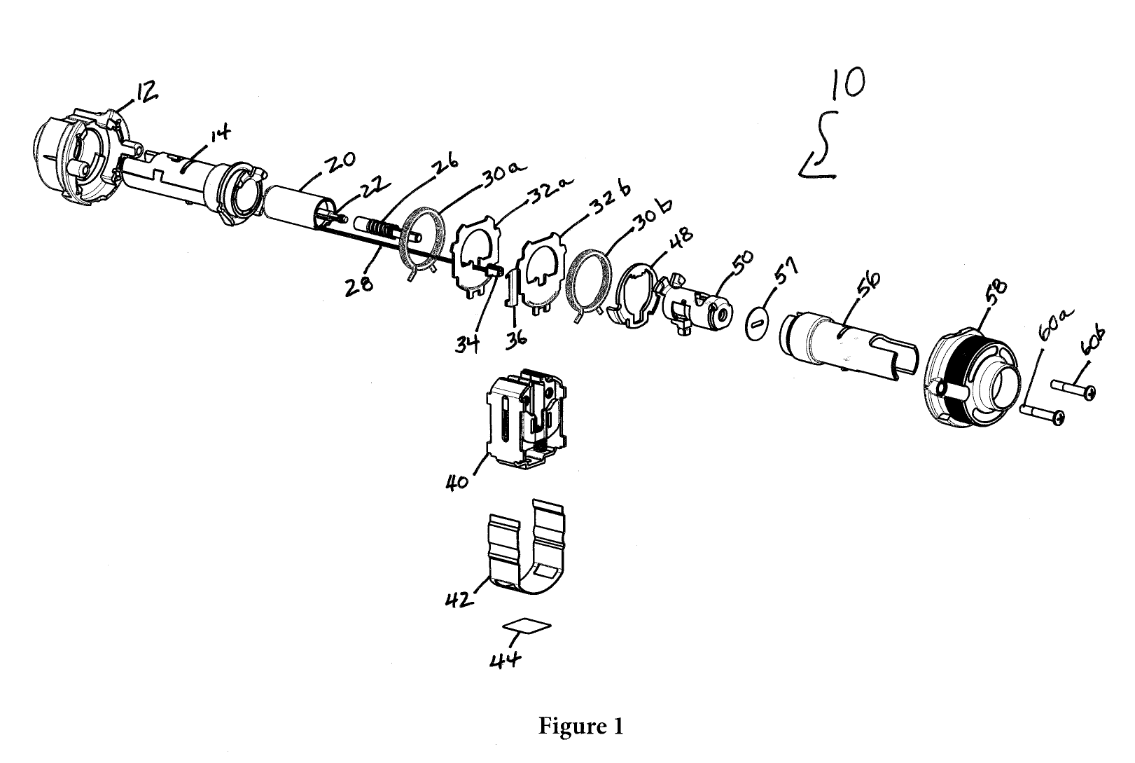

With reference now to the drawings, in particular to FIGS. 1-5B, thereof, apparatuses embodying features, principles, and concepts of various exemplary embodiments of motorized cylindrical lock will be described.

Referring to FIG. 1, there is illustrated one embodiment of an exploded view of a motorized cylindrical lock 10. The motorized cylindrical lock 10 includes an inside hub and locking pin assembly 12, a non-keyed sleeve and driver assembly 14, a motor assembly 20, a spindle 22 connectedly affixed to the motor assembly 20, a threaded plunger 26, a wire 28, a plurality of lever spring returns 30a, 30b, a plurality of thrust plates 32a, 32b, a connector 34 connectedly affixed to the wire 28, a wire protection cap for thrust plate spacer bearing 36, a chassis frame and retractor assembly 40, a chassis cover 42, a chassis label 44, a spring plate for a keyed sleeve 48, a key release for cam assembly 50, a throw member block 57, a keyed sleeve assembly 56, an outside hub 58, and a plurality of screws 60a, 60b. The motorized lock includes a battery-powered motor assembly, a chassis, an “R” function cam assembly and a lost motion hub. Some operators are not explained as the operators and related functionality are known in the industry. In this illustration there are keyed and non-keyed sleeves, however, the invention is not limited in this regard and can have two keyed sleeves, two non-keyed sleeves or a combination thereof. The motorized cylindrical lock 10 can include a number of interior and exterior actuators, such as levers or knobs (not shown), coupled to a latch bolt such that the rotation of either lever will retract the latch bolt to allow a door to open.

In operating the motorized lock cylinder 10 an electric signal can be transmitted to the wire 28 by an exterior operator such as a mechanical key or by wireless signal, such as a radio frequency from a fob device (not shown) to operate the motorized lock cylinder 10. The signal can be transmitted to the motor assembly 20 causing a coupling mechanism of the spindle 22 to push against the threaded plunger 26. The threaded plunger 26 can be operately connected through the chassis 40 to translate a bias force to the key release cam assembly 50 to push the locking lug 54 to move the latch bolt for orientation into a locked state. This state can turn the motorized cylindrical lock 10 into a storeroom function that causes the latch bolt or locking lug 54 to be always locked unless specifically accessed, such as by a key or control device. Control devices can include a mechanical key, fob, mobile phone or the like.

An electric signal can also be transmitted to the wire by a mechanical key or by wireless signal for changing the state of the lock into a classroom function. An electric signal can be transmitted to the motor assembly 20 causing the spindle 22 to retract from the threaded plunger 26. The threaded plunger 26 can be operately detached through the chassis 40 to retract from latch bolt or locking lug 54 to move the lock for orientation into an unlocked state. Although in this embodiment the term locking lug 54 is used, it is interchangeable with latch bolt, bolt, lock, etc. Although in this example, the electric signal is transmitted through a wire the signal can also be transmitted wireless such as by the locking assembly including an antenna to receive radio frequency (RF) signals from a key unit such as a fob, a reader receiving the RF signal and authenticating whether the key unit is authorized, and a circuit board configured to transmit the RF signal to one or more assemblies, such as the key release cam assembly 50 in the motorized cylindrical lock assembly 10. In at least one embodiment the preferred radio frequency range can be 900 MHz by either a long radio range or Ethernet gateway. The wireless signals can also be transmitted through a plurality of communicators or repeaters to remotely operate one or more assemblies from a distance in the motorized cylindrical lock assembly 10.

In the instance where the motorized lock cylinder is operated from an exterior actuator such as placing a mechanical key into the lock, a lever (not shown) can be operated to create a bias force unto the motor assembly causing the spindle to interact with the threaded plunger 26 to push against the locking lug 54 for operation of the motorized cylindrical lock 10 into an locked or unlocked state. The plurality of return springs 30a, 30b can be used to return the external actuator, such as a lever to a zero balance point. The plurality of return springs 30a, 30b can be assembled against the chassis in a flat orientation.

Although the wire 28 shown in FIG. 1 is illustrated to be straight through the chassis, the wire 28 can routed and configured for compact securing around and through the chassis 40 so that the wired 28 is not twisted. In a preferred embodiment for operating the motorized cylindrical lock 10 the plurality of chassis screws 60a, 60b can be installed with a torque range of 17-20 lbs.

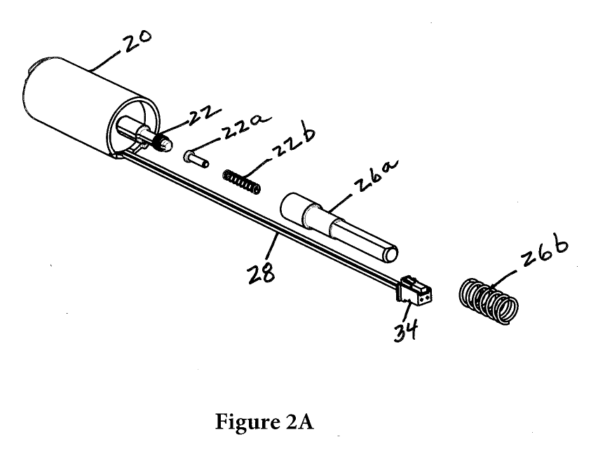

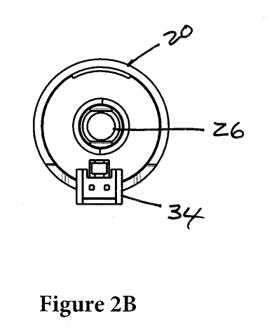

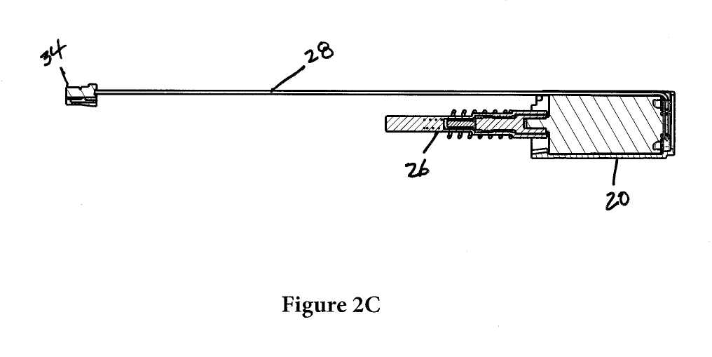

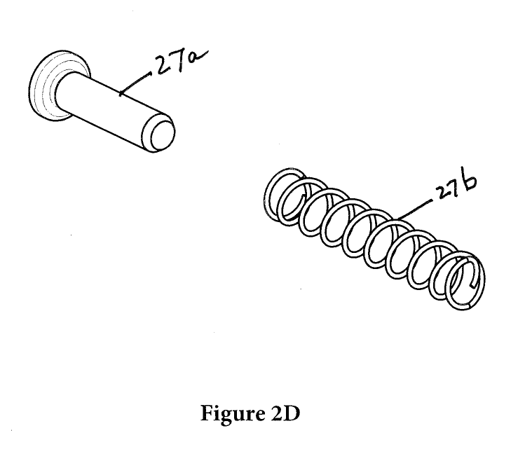

Referring now to FIG. 2A, there is illustrated a partial exploded view of the motor assembly of the motorized cylindrical lock 10. FIG. 2A shows the motor assembly 20, the spindle 22 including a spring guide pin 22a and a hub lever compression spring 22b, the threaded plunger 26 exploded to show a plunger 26a and a plunger spring 26b. FIG. 2B shows the front view of the motor assembly 20 as shown in FIG. 2A, the threaded plunger 26, and the connector 34 communicatively attached to the wire 28. FIG. 2C illustrates a cross-sectional view of the motor assembly 20 as shown in FIG. 2A, the threaded plunger 26, and the connector 34 communicatively attached to the wire 28. FIG. 2D illustrates an alternate embodiment of the threaded plunger 26 and shows a rounded plunger 27a and a plunger spring 27b with bent spring legs.

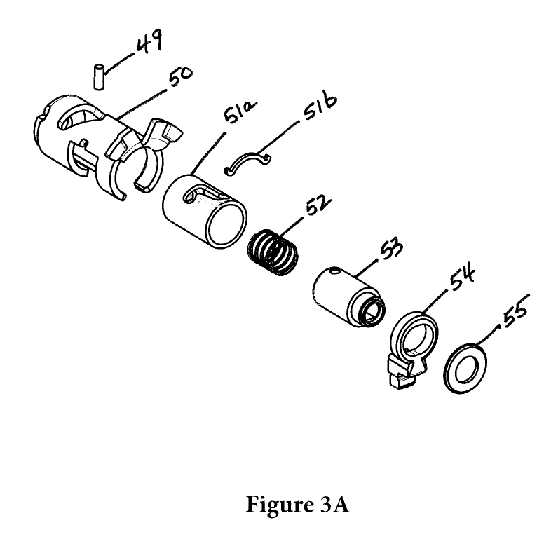

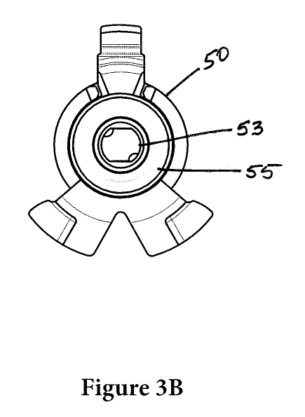

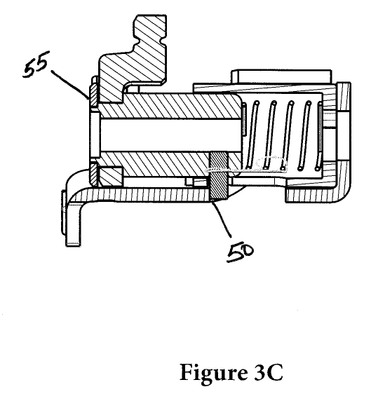

Referring now to FIG. 3A there is illustrated a partial exploded of the key release cam assembly 50 of the motorized cylindrical lock 10. FIG. 3A shows a key release cam 50, a retainer pin 49 for the key release cam assembly 50, a locking cam function sleeve 51a, a locking cam retainer 51b, a key release spring 52, a locking lug bushing 53, a locking lug 54, and a bushing washer 55. FIG. 3B illustrates a front view of the key release cam assembly 50 as shown in FIG. 3A, the locking lug bushing 53, and the bushing washer 55 of the motorized cylindrical lock 10. FIG. 3C illustrates a cross-sectional view of the key release cam assembly 50 and the bushing washer of the motorized cylindrical lock 10.

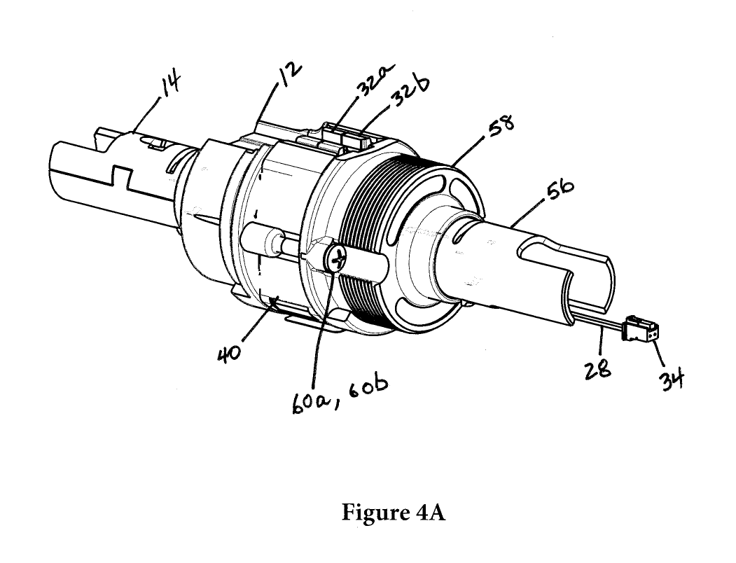

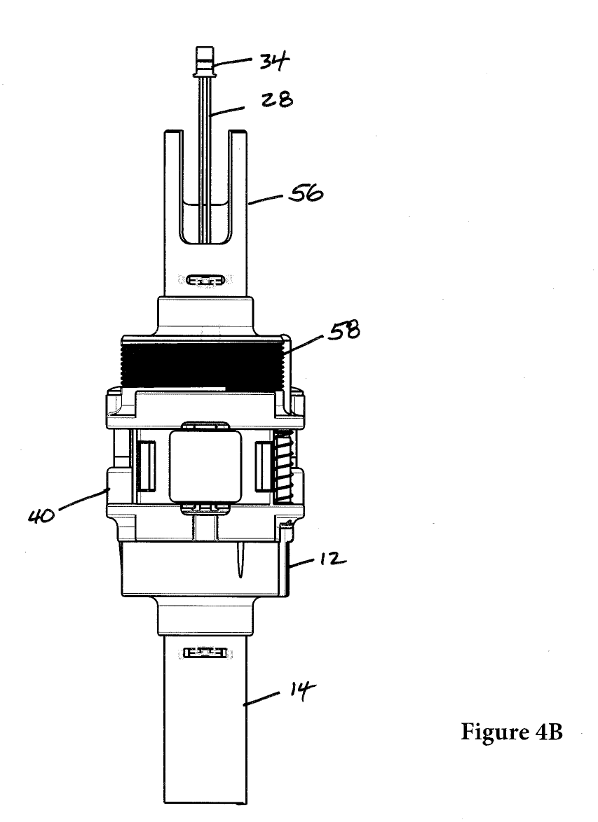

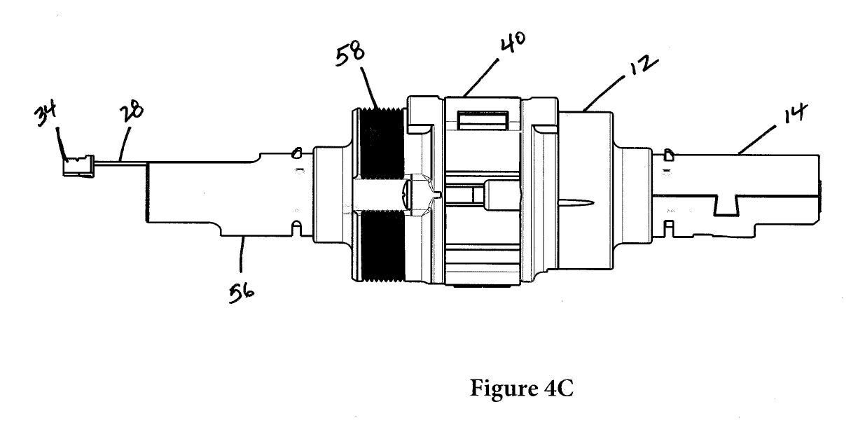

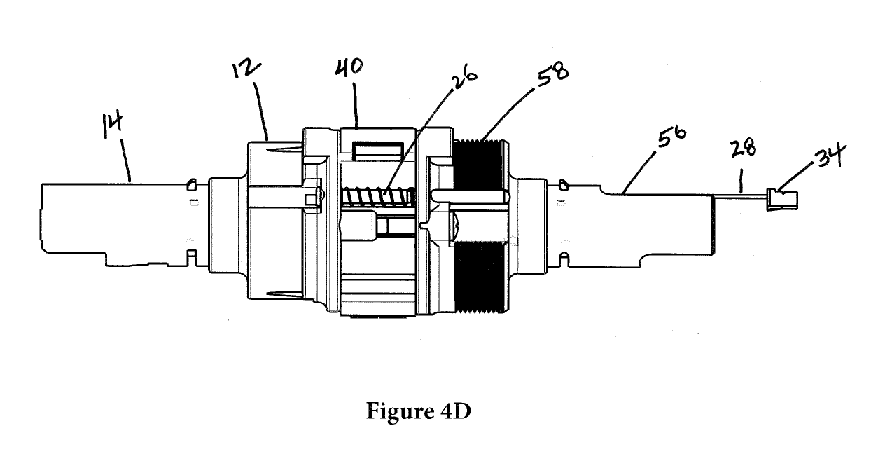

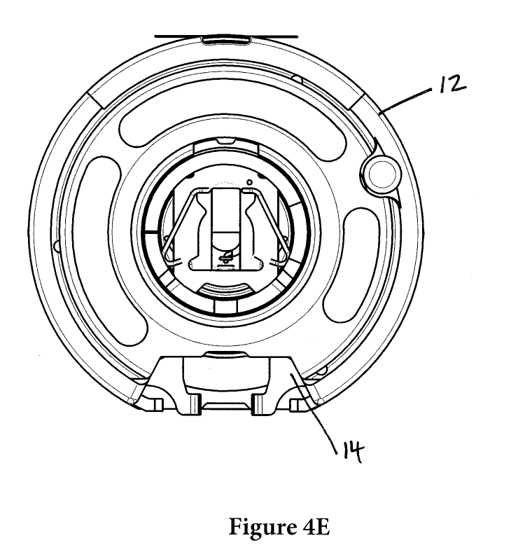

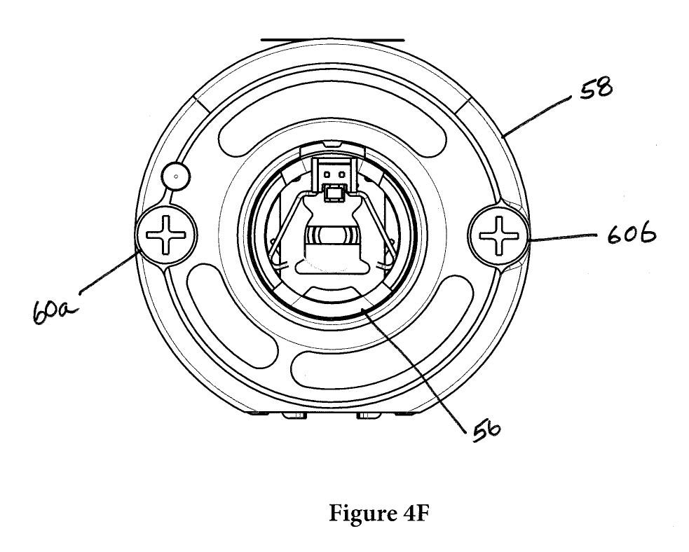

FIG. 4A illustrates a constructed, perspective view of the motorized cylindrical lock 10 shown in FIG. 1. FIG. 4A shows the non-keyed sleeve and driver assembly 14, the inside hub and locking assembly 12, the chassis 40, the plurality of thrust plates 32a, 32b, the outside hub 58, the keyed sleeve assembly 56, the connector 34 communicatively connected to the wire 28, and the plurality of chassis screws 60a, 60b.

FIG. 4B illustrates a top view of the motorized cylindrical lock 10 as shown in FIG. 4A, the non-keyed sleeve and driver assembly 14, the inside hub and locking assembly 12, the chassis 40, the outside hub 58, the keyed sleeve assembly 56, and the connector 34 communicatively connected to the wire 28. FIG. 4C illustrates a left side view of the motorized cylindrical lock 10 as shown in FIG. 4A, the non-keyed sleeve and driver assembly 14, the inside hub and locking assembly 12, the chassis 40, the outside hub 58, the keyed sleeve assembly 56, and the connector 34 communicatively connected to the wire 28. FIG. 4D illustrates a right side view of the motorized cylindrical lock 10 as shown in FIG. 4A, the non-keyed sleeve and driver assembly 14, the inside hub and locking assembly 12, the chassis 40, the threaded plunger 26, the outside hub 58, the keyed sleeve assembly 56, and the connector 34 communicatively connected to the wire 28.

FIG. 4E illustrates a front view of the motorized cylindrical lock 10 as shown in FIG. 4A, the non-keyed sleeve and driver assembly 14, and the inside hub and locking assembly 12. FIG. 4F illustrates a back view of FIG. 4A. FIG. 4E illustrates a back view of the motorized cylindrical lock 10 as shown in FIG. 4A, the outside hub 58, the keyed sleeve assembly 56, and the plurality of chassis screws 60a, 60b.

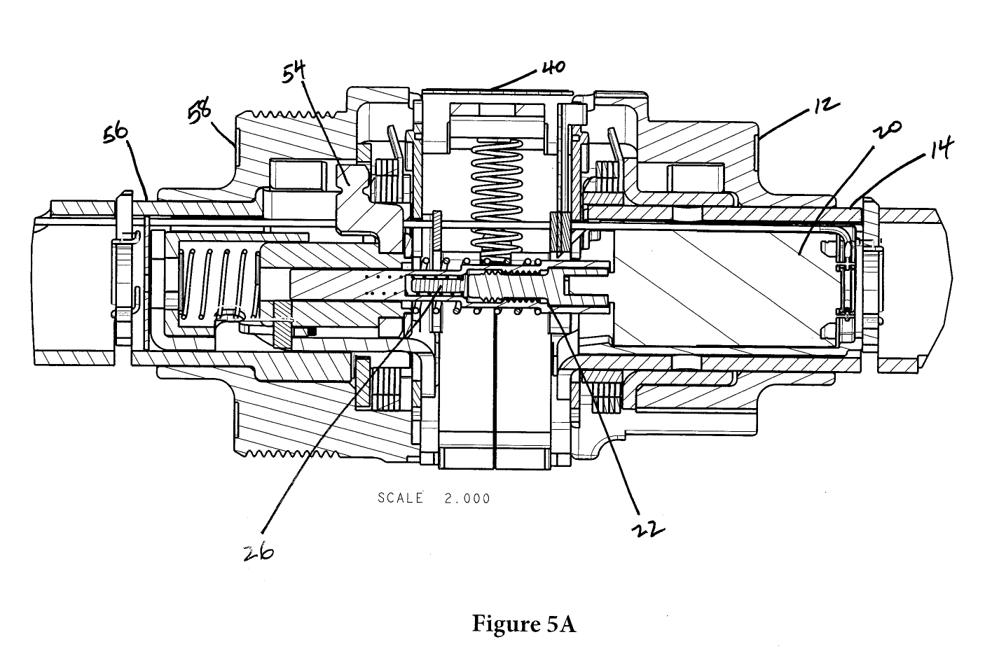

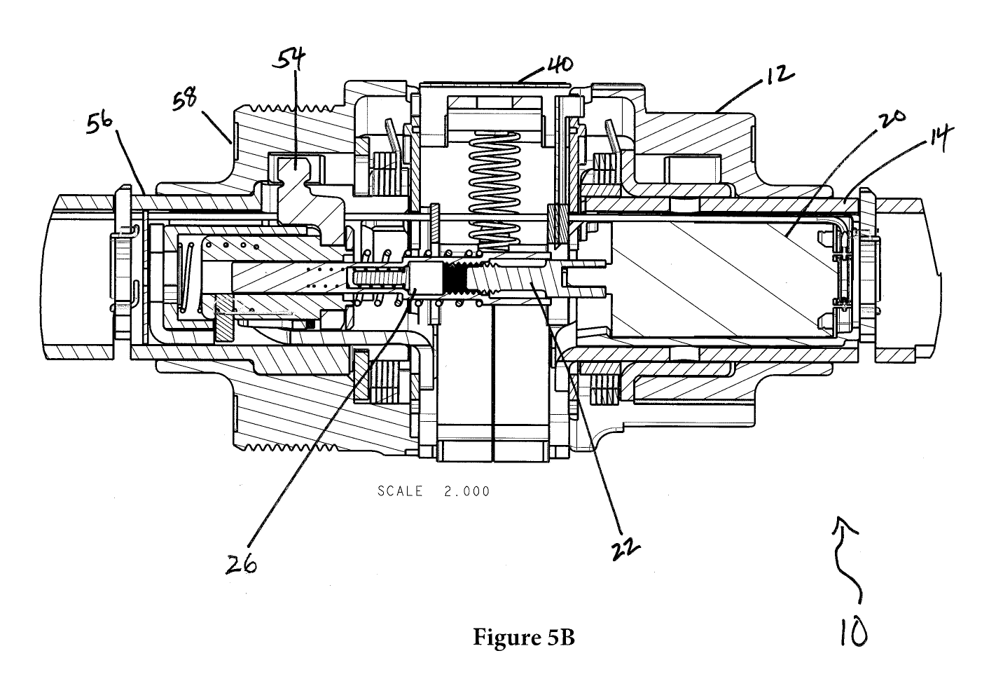

FIG. 5A illustrates a cross-sectional view of the constructed motorized cylindrical lock 10 in an unlocked position. FIG. 5A shows the non-keyed sleeve and driver assembly 14, the inside hub and locking assembly 12, the motor assembly 20, the spindle 22, the threaded plunger 26, the chassis 40, the outside hub 58, the keyed sleeve assembly 56, the outside hub 58 and the plurality of chassis screws 60a, 60b.

FIG. 5B illustrates a cross-sectional view of the constructed motorized cylindrical lock 10 in a locked position. FIG. 5B shows the non-keyed sleeve and driver assembly 14, the inside hub and locking assembly 12, the motor assembly 20, the spindle 22, the threaded plunger 26, the chassis 40, the outside hub 58, the keyed sleeve assembly 56, the outside hub 58 and the plurality of chassis screws 60a, 60b.

The present invention involves obtaining information utilized to operate a plurality of motorized locks by sending a wireless signal to the plurality of motorized locks for operation in a number of lock modes. Certain embodiments use a system or remote access to control a plurality of motorized cylindrical locks.

In one embodiment, a motorized lock exists for the storeroom function. In at least one embodiment, the electrification of the motorized lock allows for the outside actuator to operate the latch bolt when the motor is in the unlocked position. Upon receipt of a lockdown signal the motor assembly 20, the spindle 20, and threaded plunder 26 will run in the locking direction which will lock the exterior lever and effectively convert the lock bolt or locking lug 54 into a Storeroom function lock, allowing access to the door only by the mechanical key retracting the latch bolt. In the motorized lock, the key can only retract the latch bolt for entry. It cannot lock the storeroom function if the motor is unlocked. The exterior lever will remain secure until a ‘cancel lockdown’ signal is received by the wireless module on the door. The reverse is true for operating in a classroom function. Upon receiving a signal, such as from a fob, for removing the lockdown the motor assembly 20, the spindle 20, and threaded plunder 26 will then run in the opposite direction, returning the lockbolt or locking lug 54 to normal classroom operation.

In at least one embodiment, a motorized lock 10 includes a battery-powered motor assembly, a digital processor chip, circuit board, and an antenna configured to receive wireless signals transmitted from a portable device such as a key fob, mobile device, computer, tablet or the like. The motorized cylindrical lock 10 can also be configured to receive wireless signals from a centralized security monitoring station. The signal can be transmitted over a WAN, a LAN, Bluetooth, cloud network, or the internet from the centralized security monitoring station to the locksets. Repeaters or the like may be used to relay the signal to the locksets.

The motorized cylindrical lock 10 can be applicable in a variety of applications and configurations for lock functionality, such as but not limited to passage latch, bath/bedroom privacy lock, office and inner entry lock, classroom lock, classroom security lock, electrically fail-safe locks, electrically fail-secure locks, and storeroom locks.

The motorized lock 10 may further include transmission means for relaying the signal from the remote source to the motorized cylindrical lock 10. The transmission means can include a WAN, a LAN, a cloud network, Bluetooth network, the internet and repeaters as necessary for a wireless signal to reach the at least one battery-powered motorized lock. The remote source can include a key fob, mobile device, computer, tablet or the like.

In at least one embodiment of the present invention, the lock system or motorized cylindrical lock 10 can be controlled by a central or host system for controlling a number of locks in a building. In at least one embodiment of the present invention, the motorized cylindrical lock 10 would further include an inside actuator and an outside actuator wherein the latch bolt is coupled to at least the inside actuator for retraction in response to rotation of the inside actuator.

Although the present invention has been described in terms of particular example and alternative embodiments, it is not limited to those embodiments. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention. Alternative embodiments, examples, and modifications which would still be encompassed by the invention may be made by those skilled in the art, particularly in light of the foregoing teachings. The example and alternative embodiments described above may be combined in a variety of ways with each other. Furthermore, the steps and number of the various steps illustrated in the figures may be adjusted from that shown.

It should be understood, therefore, that the invention is not limited to the specific embodiments disclosed herein, and that modifications and other embodiments of the invention are intended to be included within the scope of the invention. Those skilled in the art should now appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

We claim:

1. A motorized lock assembly, comprising:
an inside hub and locking pin assembly having an interior opening;
a sleeve and driver assembly operately coupled into the inside hub and locking pin assembly;
a motor assembly having a motor actuating mechanism;
a spindle operately connectedly affixed to the motor assembly;
a threaded plunger adapted to receive force from the spindle and configured to activate one or more lock assembly operations;
a coupling mechanism drivably coupled to the outer spindle;
a plurality of lever spring returns configured to return one or more levers to zero position after an operation;
a plurality of thrust plates configured to hold a plurality of sleeves are in position;
a chassis frame and retractor assembly having a bolt actuator mechanism configured to retract a latch bolt;
a key release for cam assembly configured to a keyed sleeve assembly and configured to rotate, and wherein the keyed sleeve assembly is operate connected to an outside lever and configured to allow lever rotation;
a spring plate for a keyed sleeve configured to translate bias force from the lever spring return to ensure one or more levers is returned to zero position after an operation; and
an outside hub assembly operately connected to an outside sleeve for threading onto a rose liner, wherein the rose liner can prevent chassis rotation.

2. The motorized lock assembly of claim 1 further comprising an exterior operator configured to wirelessly operate the lock assembly.

3. The motorized lock assembly of claim 1 further comprising an exterior operator configured to operate the lock assembly.

4. The motorized lock assembly of claim 1, the motor assembly including a motor having a motor shaft, the motor shaft being drivably coupled to a locking spindle assembly to operate the coupling mechanism when the motor assembly is actuated, wherein the coupling mechanism includes spring guide pin operately connected to a lever compression spring and the threaded plunger including a plunger spring for translating a bias force to the key release cam assembly for pushing the locking lug into a plurality of positions.

5. The motorized lock assembly of claim 1, the key release assembly for cam assembly including a key release cam for engaging retracting of the latch bolt, a locking lug operately coupled to a locking lug bushing and configured to engage a locking cam function for securing into a mechanically locked state, and a cam spring configured to translate a bias force to the locking lug bushing to return one or more locked states.

6. The motorized lock assembly of claim 1, the chassis frame and retractor assembly including a chassis operately connected to the key release cam assembly and configured to retract a latch bolt.

7. The motorized lock assembly of claim 1, wherein a wire having a connector disposed onto at least one end is communicatively connected to the motor assembly, the wire configured to transfer electrical signal to the key release cam assembly.

8. The motorized lock assembly of claim 1, wherein the wire configured to transfer electrical signal to operate locking and unlocking of the latch bolt.

9. The motorized lock assembly of claim 1, further comprising a plurality of screws operately coupled to the chassis frame and retractor assembly to hold a plurality of chassis components together.

10. The motorized lock assembly of claim 1, the inside hub and locking pin assembly operately connected to a sleeve and driver assembly configured to contain the motor, and the sleeve and driver assembly configured to mount the interior operator handle in driving engagement for driving the outer spindle.

11. The motorized lock assembly of claim 1, the outside hub assembly including a housing configured to contain the motor, the housing having an exterior shape that corresponds to an interior shape of the mounting opening of the interior operator handle for mounting the interior operator handle in driving engagement for driving the outer spindle.

12. The motorized lock assembly of claim 1 wherein at least one motorized lock assembly can be battery powered and configured for local actuation by a mechanical key and for remote actuation by an electric signal.

13. A lock control system, comprising:
a key unit comprising an antenna and a transmitter configured to transmit a radio frequency (RF) signal over the antenna; and
a plurality of lock units configured to accept one or more commands, each lock unit comprising:
a lock assembly having a motor assembly, a key release assembly, and a chassis assembly, the lock assembly configured to operate a latch bolt in a plurality of positions;
an antenna for receiving the RF signal from the key unit; and
a reader coupled to the antenna for receiving the RF signal from the key unit, authenticating whether the key unit is authorized, and if the key unit is authenticated, granting access to a secured resource;
a circuit board configured to transmit the RF signal to one or more assemblies in the lock assembly; and
wherein at least one of the lock units is configured to respond to RF signals and operate a latch bolt in an one of an unlocked or locked position.

14. The lock control system of claim 13, further comprising a plurality of communicators configured to wirelessly communicate with the one or more lock assemblies, the plurality of communicators providing one or more commands to the lock assemblies.

15. The lock control system of claim 13, further comprising a plurality of communicators configured to extend wireless communication with one or more lock assemblies.

16. The lock control system of claim 15, wherein a central host including a database of authentication information, the central host being configured to receive updated authentication information and to communicate the updated authentication information to the plurality of communicators.

17. The lock control system of claim 13, wherein a central host including a database of authentication information, the central host being configured to receive updated authentication information and to communicate the updated authentication information to the each of the plurality of lock assemblies configured to accept one or more commands.
